(19) United States
(12) Patent Application Publication
(10) Pub. No.: US 2018/0269563 A1
(43) Pub. Date: Sep. 20, 2018

(54) APPARATUS AND METHOD FOR REDUCING VIBRATION FREQUENCY TRANSMISSION IN SMALL BASE STATION ANTENNA

(71) Applicant: CommScope Technologies LLC, Hickory, NC (US)

(72) Inventors: Hongjun QIAN, Suzhou (CN); Yongzhong LI, Suzhou (CN); Junfeng YU, Suzhou (CN)

(21) Appl. No.: 15/542,604

(22) PCT Filed: Aug. 5, 2015
(86) PCT No.: PCT/US2015/043801

§ 371 Date: Jul. 10, 2017

(30) Foreign Application Priority Data
Jan. 29, 2015 (CN) 201510044792.7

(51) Int. Cl. H01Q 1/24; H01Q 1/00; H04B 1/40; H01Q 1/12

(52) U.S. Cl. CPC H01Q 1/246; H01Q 1/1207; H04B 1/40; H01Q 1/005

(57) ABSTRACT

A small base station antenna is disclosed, said small base station antenna having a length less than 0.4 m, and comprising a carriage, an antenna core assembly and an antenna shell, said small base station antenna capable of being mounted to a holding pole at one point through a mounting rack, characterized in that said small base station antenna further comprises a shock absorption part disposed between the carriage and the antenna shell so as to reduce the vibration frequency transmitted into the antenna core assembly. A method for reducing vibration frequency transmission in a small base station antenna is further disclosed. The present invention addresses the issue that a small base station antenna operates normally under high frequency vibration, such that the small base station antenna can pass the sinusoidal vibration test and random vibration test required by the industry, and can even pass the stricter impact test.

### CROSS-REFERENCE TO RELATED APPLICATIONS

This application claims the benefit of Chinese Patent Application 201510044792.7 filed Jan. 29, 2015, the entire contents of which are incorporated herein by reference in their entirety.

### FIELD OF THE INVENTION

The present invention relates to an apparatus and method for reducing vibration frequency transmission in a small base station antenna.

### DESCRIPTION OF THE RELATED ART

To meet the requirements of LTE (long term evolution) wireless communication standards, base station antennas tend to employ the miniaturization design. Small base station antennas (typically having a length less than 0.4 m) are mainly used on urban streets and densely distributed, for example, mounted on street light poles. FIG. 1 illustrates the mounting of a small base station antenna onto a holding pole. The small base station antenna shown in FIG. 1 has a length of about 0.4 m, and the mounting thereof is one point mounting to a holding pole 2 through a mounting rack.

However, environmental testing requirements for small base station antennas are the same as those for large base station antennas (typically having a length greater than 1.3 m), both of which need to pass sinusoidal vibration test and random vibration test required by the industry, and may even need to pass the stricter impact test. It has imposed a greater challenge on the structure of small base station antennas.

The frequency of sinusoidal vibration of existing large base station antennas typically having a length greater than 1.3 m is usually a relatively low frequency of 20 to 30 Hz. To a small base station antenna typically having a length less than 0.4 m, however, the frequency of sinusoidal vibration is usually a relatively high frequency of 90 to 100 Hz. High frequency amplitude will more easily damage welded connections inside an antenna, such as soldering points between a coaxial phase cable and a printed circuit board, soldering points between an antenna transmission unit and a printed circuit board. Since it is very difficult to adjust a small base station antenna's own size and quality, the conventional method that changes amplitude by changing mass cannot meet the environmental testing requirements for small base station antennas.

### SUMMARY OF INVENTION

The object of the present invention is to address the issue that a small base station antenna operates normally under high frequency vibration, such that the small base station antenna can pass the sinusoidal vibration test and random vibration test required by the industry, and can even pass the stricter impact test.

The above object is attained through an apparatus and method for reducing vibration frequency transmission in a small base station antenna.

The present invention discloses a small base station antenna, said small base station antenna having a length less than 0.4 m, and comprising a carriage, an antenna core assembly and an antenna shell, said small base station antenna capable of being mounted to a holding pole at one point through a mounting rack, characterized in that said small base station antenna further comprises a shock absorption part disposed between the carriage and the antenna shell for reducing the vibration frequency transmitted into the antenna core assembly.

The present invention further discloses a method for reducing vibration frequency transmission in a small base station antenna, said small base station antenna having a length less than 0.4 m, and comprising a carriage, an antenna core assembly and an antenna shell, said small base station antenna capable of being mounted to a holding pole at one point through a mounting rack, said method comprising a shock absorption part disposed between the carriage and the antenna shell so as to reduce the vibration frequency transmitted into the antenna core assembly.

Preferably, the shock absorption part is a pad made of a shock absorption material. The shock absorption material is preferably a closed cell material. The shock absorption material may also be a silica gel material. The shape of the pad is preferably substantially rectangular, one pair of sides has a length of about 160 mm, the other pair of sides has a length of about 48 to 250 mm, and the thickness of the pad is preferably about 1.14 to 3.18 mm.

Preferably, the shock absorption part comprises a pad made of the shock absorption material and a thin-walled metal sleeve, the metal sleeve supports the pad for coordination with installation, so as to further reduce the vibration frequency transmitted into the antenna core assembly. The shock absorption material is preferably a closed cell material. The shock absorption material may also be a silica gel material. The metal sleeve is preferably a brass pipe. The metal sleeve may also be an aluminum pipe or stainless steel pipe. The shape of the pad is preferably substantially rectangular, both pairs of sides have a size of 30 to 50 mm, the thickness of the pad is preferably about 3.18 mm. The wall thickness of the metal sleeve is preferably about 0.5 to 1.0 mm. The height of the metal sleeve is preferably about 2 mm.

### BRIEF DESCRIPTION OF THE DRAWINGS

Preferred embodiments of the present invention are described below with reference to the accompanying drawings, which will make various objects, features and advantages of the present invention more obvious. In the accompanying drawings, the same legends constantly indicate the same or similar parts.

FIG. 1 illustrates the mount of a small base station antenna.

FIG. 2 illustrates that a pair of closed cell pads are used as the shock absorption part for a small base station antenna.

FIG. 3 illustrates that one closed cell pad is used as the shock absorption part for a small base station antenna.

FIG. 4 illustrates an antenna shell.

FIG. 5 illustrates that a closed cell pad and a metal sleeve are used as the shock absorption part for a small base station antenna.

FIG. 6 illustrates the mount of the shock absorption part between the carriage and the antenna shell.

### DETAILED DESCRIPTION OF THE INVENTION

The detailed description below is essentially exemplary, rather than a limitation to the scope, applicability or structure of the present invention in any way. In addition, the description below only provides a few examples of implementation of the present invention. Those skilled in the art should understand that many provided examples have a variety of appropriate substitutions.

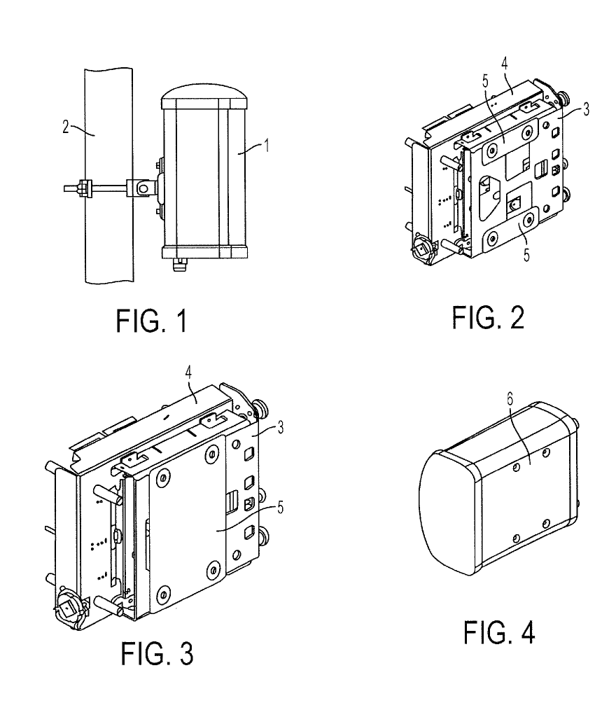

Examples of the present invention will be described below with reference to FIGS. 1 to 5.

As shown in FIGS. 1 to 4, in Example 1, the small base station antenna 1 has a length less than 0.4 m, and it can be mounted to a holding pole 2 at one point through a mounting rack 14. The small base station antenna 1 comprises a carriage 3, an antenna core assembly 4 and an antenna shell 6. A shock absorption part is disposed between the carriage 3 and the antenna shell 6 for reducing the vibration frequency transmitted into the antenna core assembly. The shock absorption part is a pad made of a shock absorption material. The shock absorption material may be a closed cell material or a silica gel material. The pad may be designed to be a closed cell pad 5 with a single face attached with a 3M double-faced adhesive tape, the closed cell pad 5 is directly attached to the bottom of the carriage 3, and the closed cell pad 5 is attached at a position corresponding to the mounting support 14 of the antenna.

As shown in FIG. 2, a pair of closed cell pads 5 may be provided. The shape of the pads is preferably substantially rectangular, one pair of sides has a length of about 160 mm, and the other pair of sides has a length of about 48 mm. The thickness of the pads is preferably about 1.14 to 3.18 mm.

As shown in FIG. 3, a single piece of closed cell pad 5 may be provided. The shape of the pad is preferably substantially rectangular, one pair of sides has a length of about 160 mm, and the other pair of sides has a length of about 250 mm. The thickness of the pad is preferably about 1.14 to 3.18 mm.

The shape, quantity or size of the pad is not limited to the above specific example, but may be selected according to a specific application.

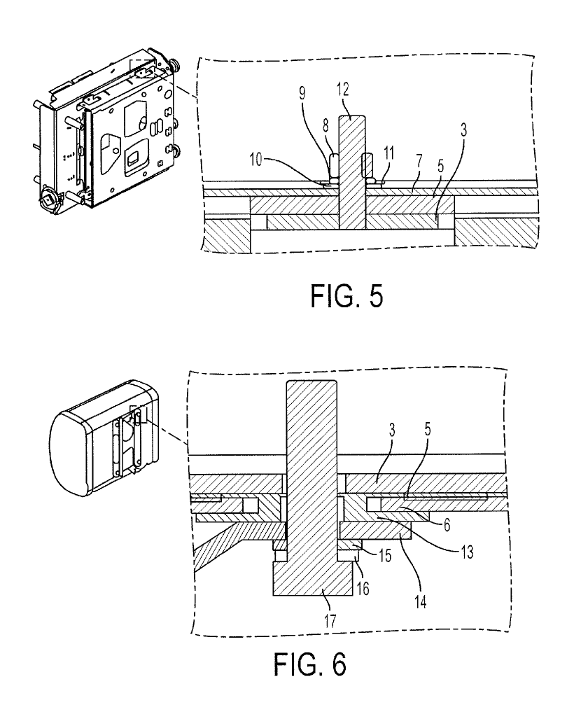

As shown in FIG. 5, in Example 2, the small base station antenna 1 has a structure substantially the same as that in Example 1, with the difference only in that the shock absorption part comprises a pad made of the shock absorption material and a thin-walled metal sleeve, the metal sleeve supports the pad for coordination with installation, so as to further reduce the vibration frequency transmitted into the antenna core assembly. The shock absorption material may be a closed cell material or a silica gel material. The pad may be designed to be a closed cell pad 5 with a single face attached with a 3M double-faced adhesive tape, the metal sleeve may be designed to be a thin-walled brass pipe 11, and the metal sleeve may also be an aluminum pipe or stainless steel pipe. The brass pipe 11 is embedded into the central hole of the closed cell pad 5, runs through a M5 pressure rivet screw 12, and is mounted between the carriage 3 and the reflection plate 7. The thin-walled brass pipe 11 can prevent the closed cell pad 5 from being completely compressed when the M5 nut 8 is tightly locked, the 3M double-faced adhesive tape on the single face of the closed cell pad 5 may be used to attach the closed cell pad 5 to the carriage 3, so as to prevent the rotation of the closed cell pad 5 during the locking process of the nut. In the example shown in FIG. 5, the shape of the pad is substantially rectangular, and both pairs of sides have a size of 30 to 50 mm. The thickness of the pad is about 3.18 mm. The wall thickness of the brass pipe 11 is about 0.5 to 1.0 mm, and the height of the brass pipe 11 is about 2 mm.

As shown in FIG. 6, in the mounting process of the mounting support 14, the closed cell pad 5 is compressed by ⅓ to ½. This is because a stepped aluminum pad 13 is provided between the mounting support 14 and the carriage 3, so as to ensure the distance between the mounting support and the carriage that the closed cell pad will not be completely compressed. In the vibration process, the compressible closed cell pad 5 can absorb a part of the vibration energy transmitted by the mounting support 14 mounted on the vibration platform, such that the vibration frequency received by the antenna core assembly 2 is reduced, thereby ensuring that the antenna core assembly 2 will not be damaged.

Although the present invention has been disclosed with reference to some examples, a variety of variations, modifications and amendments may be made to the described examples without departing from the scope and category of the present invention. Therefore, it should be understood that the present invention is not limited to the described examples, but has an entire scope defined by the text of the appended claims and equivalent contents thereof.

### LIST OF LEGENDS

1 Small base station antenna

2 Holding pole

3 Carriage

4 Antenna core assembly

5 Closed cell pad

6 Antenna shell

7 Reflection plate

8 M5 nut

9 M5 spring gasket

10 M5 flat gasket

11 Brass pipe

12 M5 pressure rivet screw riveted on the carriage

13 Stepped aluminum pad

14 Mounting support

15 M8 flat gasket

16 M8 spring gasket

17 M8 bolt

1. A small base station antenna, the small base station antenna having a length less than 0.4 m, and comprising a carriage, an antenna core assembly and an antenna shell, the small base station antenna capable of being mounted to a holding pole through a mounting rack, wherein the small base station antenna further comprises a shock absorption part disposed between the carriage and the antenna shell for reducing the vibration frequency transmitted into the antenna core assembly.

2. The small base station antenna according to claim 1, wherein the shock absorption part is a pad made of a shock absorption material.

3. The small base station antenna according to claim 2, wherein the shock absorption material is a closed cell material or a silica gel material, the shape of the pad is substantially rectangular, one pair of sides has a length of about 160 mm, the other pair of sides has a length of about 48 mm to about 250 mm, and the thickness of the pad is about 1.14 mm to about 3.18 mm.

4. The small base station antenna according to claim 1, wherein the shock absorption part comprises a pad made of a shock absorption material and a thin-walled metal sleeve, the metal sleeve supports the pad for coordination with installation, so as to further reduce the vibration frequency transmitted into the antenna core assembly.

5. The small base station antenna according to claim 4, wherein the shock absorption material is a closed cell material or a silica gel material, the metal sleeve is a brass pipe, an aluminum pipe or a stainless steel pipe, the shape of the pad is substantially rectangular, both pairs of sides have a size of about 30 mm to about 50 mm, the thickness of the pad is about 3.18 mm, the wall thickness of the metal sleeve is about 0.5 mm to about 1.0 mm, and the height of the metal sleeve is about 2 mm.

6. A method for reducing vibration frequency transmission in a small base station antenna, the method comprising: providing the small base station antenna having a length less than 0.4 m, and comprising a carriage, an antenna core assembly and an antenna shell, the small base station antenna capable of being mounted to a holding pole through a mounting rack, wherein the small base station antenna further comprises a shock absorption part disposed between the carriage and the antenna shell; and reducing the vibration frequency transmitted into the antenna core assembly.

7. The method according to claim 6, wherein the shock absorption part is a pad made of a shock absorption material.

8. The method according to claim 7, wherein the shock absorption material is a closed cell material or a silica gel material, the shape of the pad is substantially rectangular, one pair of sides has a length of about 160 mm, the other pair of sides has a length of about 48 mm to about 250 mm, and the thickness of the pad is about 1.14 mm to about 3.18 mm.

9. The method according to claim 6, wherein the shock absorption part comprises a pad made of a shock absorption material and a thin-walled metal sleeve, the metal sleeve supports the pad for coordination with installation, so as to further reduce the vibration frequency transmitted into the antenna core assembly

10. The method according to claim 9, wherein the shock absorption material is a closed cell material or a silica gel material, the metal sleeve is a brass pipe, an aluminum pipe or a stainless steel pipe, the shape of the pad is substantially rectangular, both pairs of sides have a size of about 30 mm to about 50 mm, the thickness of the pad is about 3.18 mm, the wall thickness of the metal sleeve is about 0.5 mm to about 1.0 mm, and the height of the metal sleeve is about 2 mm.

11. A small base station antenna, comprising:
a carriage;
an antenna core assembly;
an antenna shell; and
a shock absorption part disposed between the carriage and the antenna shell, wherein the shock absorption part comprises a pad made of a shock absorption material to reduce vibration frequency transmitted into the antenna core assembly.

12. The small base station antenna of claim 11, wherein the small base station antenna has a length less than about 0.4 m.

13. The small base station antenna of claim 11, wherein the shock absorption material is a closed cell material or a silica gel material.

14. The small base station antenna of claim 11, wherein the pad is substantially rectangular in shape, one pair of sides having a length of about 160 mm, the other pair of sides having a length of about 48 mm to about 250 mm, and a thickness of about 1.1 mm to about 3.2 mm.

15. The small base station antenna of claim 11, wherein the small base station antenna is configured to be mounted to a holding pole through a mounting rack.

16. The small base station antenna of claim 11, wherein the shock absorption part further comprises a thin-walled metal sleeve to reduce vibration frequency transmitted into the antenna core assembly.

17. The small base station antenna of claim 16, wherein the metal sleeve comprises a brass pipe, an aluminum pipe, or a stainless steel pipe.

18. The small base station antenna of claim 16, wherein the pad is substantially rectangular in shape, both pairs of sides having a length of about 30 mm to about 50 mm, and a thickness of about 3.2 mm, and wherein the metal sleeve has a wall thickness of about 0.5 to about 1.0 mm and a height of about 2.0 mm.

19. The small base station antenna of claim 11, wherein the shock absorption part comprises two or more pads.
